(19) United States
(12) Patent Application Publication
(10) Pub. No.: US 2011/0214307 A1
(43) Pub. Date: Sep. 8, 2011

(54) DOUBLE OFFSET MEASUREMENT CALIPERS

(76) Inventor: David Tom, San Francisco, CA (US)

(21) Appl. No.: 12/694,266

(22) Filed: Jan. 27, 2010

(51) Int. Cl. G01B 5/14; G01B 5/00

(52) U.S. Cl. 33/784; 33/810; 33/783

(57) ABSTRACT

A caliper of a type used in measurements in which the invention comprises including offset measurement jaws deployed at an angle to the main plane of said caliper for measuring dimensions offset from the main plane of said caliper. Said caliper may also include means for measuring both internal dimensions and external dimensions, and may further include a readout, such as digital or analog readout means.

### CROSS REFERENCE TO RELATED APPLICATIONS

| | | |
|---|---|---|
| 4,908,953 | March 1990 | Walliser |
| 4,945,651 | August 1990 | Georg |
| 4,982,509 | January 1991 | Luttmer et al |
| 5,036,596 | August 1991 | Gyoury et al |
| 5,404,317 | April 1995 | Song et al |
| 6,055,728 | August 2000 | Howie |
| 6,195,668 | February 2001 | Toyosawa et al |
| 6,263,585 | July 2001 | Dickinson et al |
| 6,314,657 | November 2001 | Kroll et al |
| 6,796,050 | September 2004 | Haimer et al |
| 7,246,032 | July 2007 | Feldman |
| 7,580,804 | August 2009 | Wixey |

### STATEMENT OF FEDERALLY SPONSORED RESEARCH/DEVELOPMENT

there is no federally sponsored research/development involved in this invention.

### REFERENCE TO A “SEQUENCE LISTING,” A TABLE, OR A COMPUTER PROGRAM LISTING APPENDIX

there are no listings, tables, or programs involved in this invention.

### BACKGROUND OF THE INVENTION

### Prior Art

Calipers are devices that measure the distance between two points, such as the opposing sides of a hole or cavity. A caliper can be as simple as a compass, comprising two legs and means for adjusting the angle between them; or more complex; such as two measurement arms protruding from, for example, a scale, or ruler. Caliper measuring arms often have inward or outward-facing measuring points or areas. In operation, measurement arm tips of said caliper are adjusted to fit across or between areas or spaces to be measured. The distance may then be read, such as by measuring between said tips.

One type of caliper is the vernier caliper, which provides measuring arms on a scale, usually with arms that are normal to said scale, and/or with either direct or dial-type readout to allow measurements to be made.

Another variation is an extension, or telescoping, caliper. While much less common, because they allow only a reduced range of measurement due to the need to telescope the parts, telescoping calipers can be used in, for example, confined areas where the maximum dimensions of said caliper must fit within the area to be measured.

Calipers can measure internal dimensions or external dimensions. For vernier calipers, scales on said calipers often include inch and/or metric measurements, such as on an upper and lower part of said scales, or a dial read out, which may be incorporated into said caliper. Vernier calipers commonly used in industry provide a precision to about two hundredths of a millimeter, or less than one thousandth of an inch.

The vernier caliper may have been the original design for a caliper, and may still be the most rugged. Said vernier caliper was invented by Pierre Vernier in 1631. Many vernier calipers allow measurements to be read more precisely from an evenly divided scale by the alignment of scales or reference marks on both the vernier plate, or slider and a scale the slider rides on. Many calipers allow readings in both metric and inch units.

A refinement to the measurement caliper is the inclusion of an analog or digital read out on which readings are displayed. Calipers with readouts often also provide for zeroing the display at any point, thereby allowing differential measurements and eliminating the need to read absolute numbers. Calipers with readouts may also contain a “reading hold” feature for locations where said caliper cannot be conveniently read, so that the reading can be more conveniently reviewed after said caliper is removed.

Vernier calipers can be used with accessories that extend their usefulness. One example, though there are many such accessories, is an attachment to facilitate measuring the center distance between holes.

However, calipers as presently known allow for only direct measurements, such as in the main plane of the caliper, and do not provide a means for measurement in an offset direction other than as an integral part of a machine or other such system. Separate calipers as presently known do not allow an arbitrary measurement offset at some distance from said main plane of said caliper, such as normal thereto.

The invention shown in U.S. Pat. No. 4,908,953 refers to a caliper-type device used as a length measuring device, with which a working length of a work piece may be determined for milling machines and sawing machines. The measuring device includes a movable buffer which is laid out and secured parallel to a table and integral thereto perpendicular to the plane of the cutting tool of a machine. An electrical sensor device operable for electrical or electronic measurements is synchronized to move with said buffer. Said sensor device is electrically connected with an indicator to provide a read out of the measurement. The '953 patent provides for an extension normal to the plane of a caliper, but only for the purpose of allowing said caliper, which is an extension-type caliper, to be easily extended, and is for measuring essentially in said plane of said caliper. The '953 invention does not anticipate the arbitrary measurement of opposing edges or surfaces offset from the plane of said caliper.

The invention shown in U.S. Pat. No. 4,945,651 refers to a caliper for measuring lengths, having a housing which has a contact plane as well as sensor pin which is arranged displaceably perpendicular thereto and is connected to an indicator instrument. Said housing having a single support foot for the universal use of said instrument, the bottom of said support foot lying in the contact plane. The '651 patent is intended to measure similarly disposed edges or surfaces rather than opposing surfaces, and for making measurements which are in the main plane of said caliper.

The invention disclosed in U.S. Pat. No. 4,982,509 is a caliper having multiple display orientations. Said caliper comprises a reader head having a reader element, and a display module. Said reader element is configured for lateral movement with respect to a calibrated reference member for making a measurement relative to a reference position on said calibrated reference member. The display module is for displaying measurement values and includes coupling hardware for connecting said display module to said reader head so said display module can be read horizontally independent of whether said reader head is oriented horizontally, vertically, or in another direction. The '509 patent is intended to measure distances along a table edge in the main plane of said caliper.

The invention disclosed in U.S. Pat. No. 5,036,596 is a caliper for the positional adjustment of cutting tools for use on machine tools with a first block having a gaging surface thereon translationally and swivelably movable on a perpendicular shaft. A second block is coupled to said first block in such a manner that the two blocks move together translationally with said first block being free to swivel relative to said second block. Said second block carries indicating means for indicating the amount of translational movement of said two blocks. The '596 invention is for measurement along an edge, and does not allow for the measurement of arbitrary edges or surfaces not substantially in the plane of said caliper and not independent of the system of the '596 invention.

U.S. Pat. No. 7,246,032 discloses a vernier-type caliper for measuring both opposing and included surfaces or edges, but requires that the object measured be within the plane of said caliper.

Other US patents that may constitute prior art are U.S. Pat. Nos. 5,404,317, 6,095,728, 6,195,668, 6,263,585, 6,314,657, 6,796,050, and 7,580,804, which are not discussed separately herein, as the inventor believes they are cumulative to the US patents discussed above and/or are not sufficiently applicable to the present invention.

There is a long-felt but unrealized need for a caliper which allows arbitrary measurements other than in the primary plane of said caliper of opposed edges or surfaces, and that may be applied to any type of caliper that may be desired for use in this manner.

### BRIEF SUMMARY OF THE INVENTION

The present invention is a caliper that provides for arbitrary precise measurements other than in the plane of said caliper, such as measurements of large bores (holes) with, for example, said bores obstructed by objects within said bores and not easily measurable in the main plane of said caliper.

The present invention provides outside and/or inside calipers capable of making measurements from, for example, an offset, such as from an essentially horizontal position into vertical bores. This invention is especially advantageous for large bores, such as are many centimeters in diameter, where said bores may also have some obstruction of said bores, for example, inserted bars or columns of material. The present invention allows such measurements to be easily made, even if said obstructions are concentric with said bores. The present invention is independent of the system or device being measured or for which the measurements are intended.

The present invention, in addition to enabling measurements outside the main plane of a caliper, may include readouts, such as digital or analog readouts. The present invention may be incorporated into extension type calipers, in addition to the commonly known scissors-type and vernier calipers, and may include “measurement hold” features, as these features are commonly known in the art. All features in prior art calipers of which the inventor has knowledge could be incorporated in calipers in accordance with the present invention, forming a part thereof.

### BRIEF DESCRIPTION OF THE SEVERAL VIEWS OF THE DRAWING

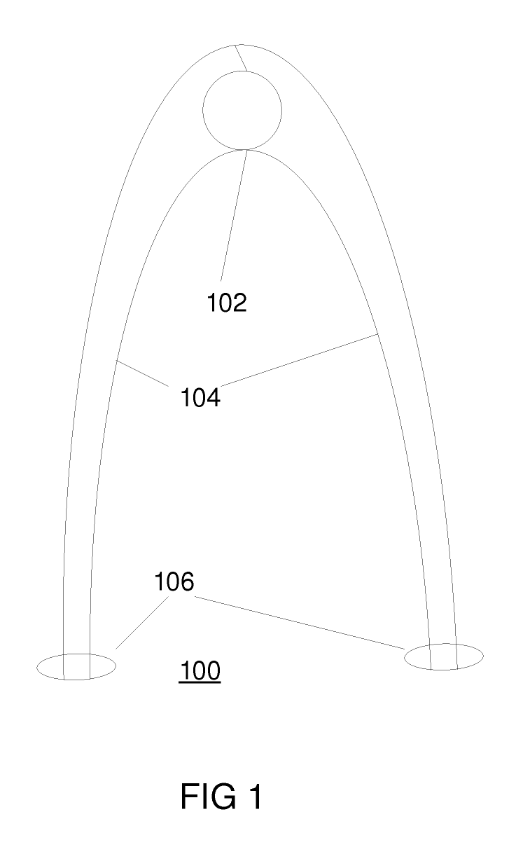

1. FIG. 1 illustrates an embodiment of a prior art caliper of a simple, scissors type.

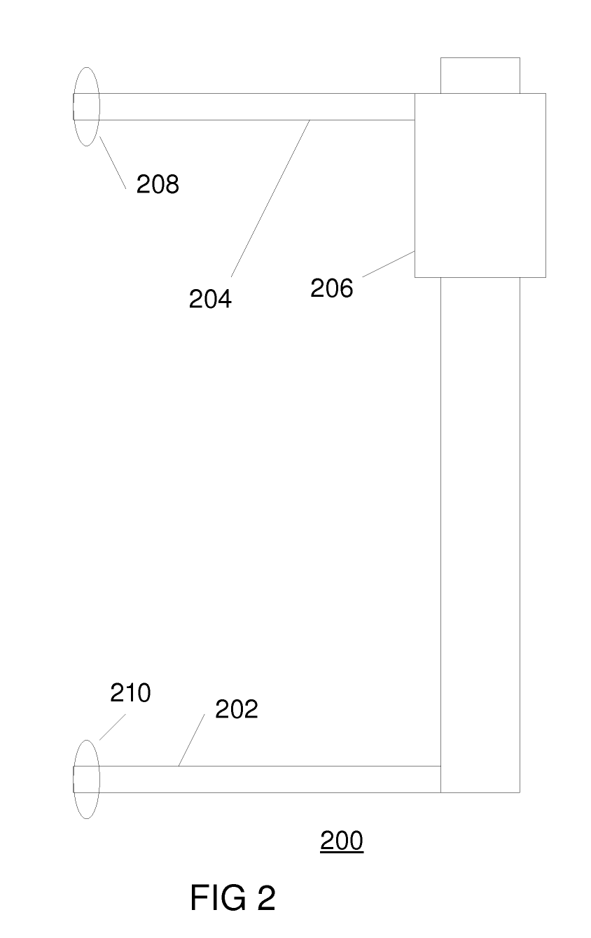

2. FIG. 2 illustrates an embodiment of a prior art caliper of a vernier type.

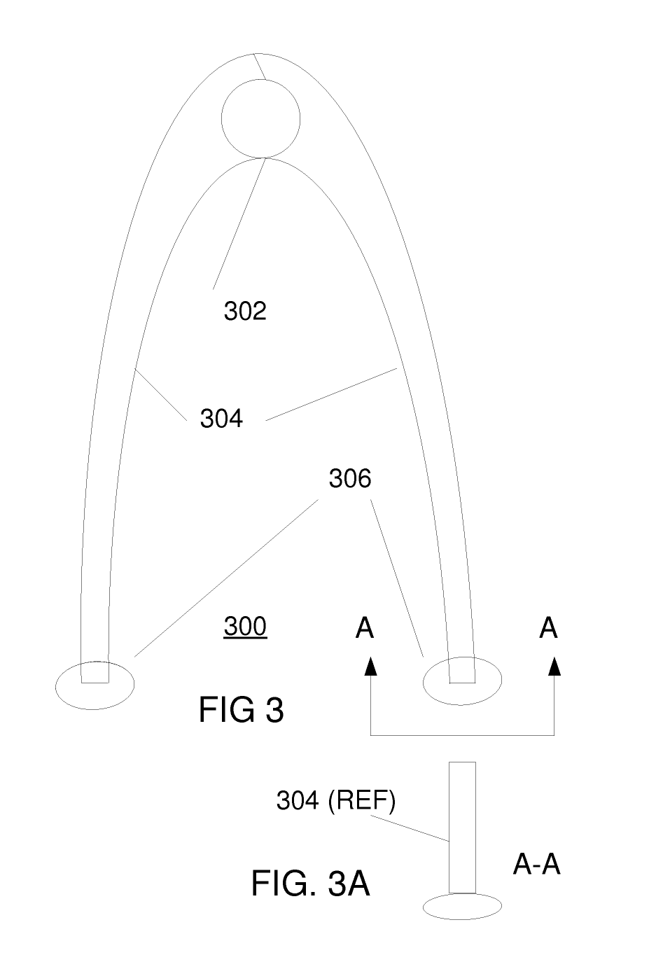

3. FIG. 3 illustrates an embodiment of a caliper in accordance with the present invention of a scissors type.

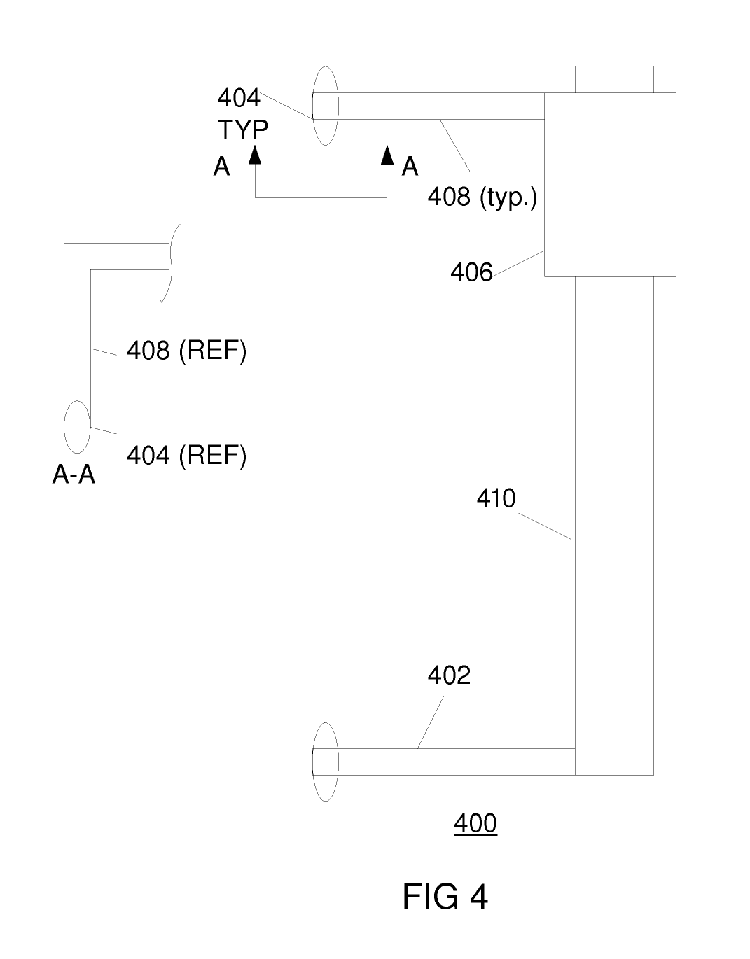

4. FIG. 4 illustrates an embodiment of a caliper in accordance with the present invention of a vernier type.

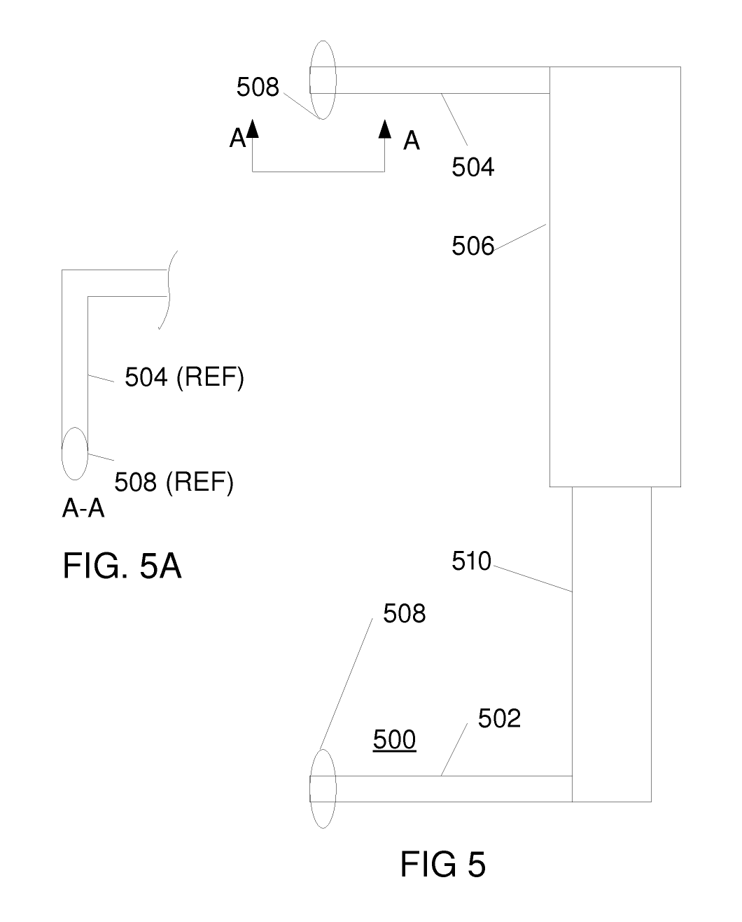

5. FIG. 5 illustrates an embodiment of an extension-type caliper in accordance with the present invention.

### DETAILED DESCRIPTION OF THE INVENTION

An embodiment of the prior art is shown in FIG. 1, which illustrates a scissors type caliper, as it is commonly known in the art. FIG. 1 is a prior art embodiment of a caliper 100, and is symmetric around hinge 102 with legs 104 and probes 106. It will be appreciated both legs 104 are often symmetrically identical, as also both probes 106. In FIG. 1, hinge 102 rotatably holds legs 104, which may be adjusted to provide a desired spacing between probes 106. Probes 106 provide for outside measurements, such as outside diameters of cylindrical objects (not shown), and inside measurements, such as inside diameters of holes or bores (not shown).

Another embodiment of the prior art is shown in FIG. 2, which illustrates a vernier type caliper 200, as it is commonly known in the art. In FIG. 2, legs 202 and 204 include probes 208 and 210. Probes 208 and 210 enable measurements of either inside or outside dimensions, as revealed in the discussion of said probes 106 associated with FIG. 1. Slider 206 is often connected rigidly to leg 204, and slides along beam 208. Leg 202 is often formed as part of beam 208, as in this FIG. 2. Beam 208 has graduations (not shown) to allow measurements in conjunction with a measurement point on slider 206, such as one of the edges of slider 206, or by means of an included hole in slider 206 (not shown). Alternatively, a dial or other readout device or method (not shown) allows measurements to be made. Such readout methods are not shown, as indicated, since they are well-known in the art, and would tend to confuse the disclosure of the invention.

An embodiment of the present invention is shown in FIG. 3 which illustrates a scissors type caliper 300 in accordance with the teachings of the present invention. In FIG. 3, caliper 300 is symmetric around hinge 302, with legs 304 and probes 306. It will be appreciated both legs are symmetrically identical, as are both probes 306. In FIG. 3, hinge 302 rotatably holds legs 304, which may be adjusted to provide a desired spacing between probes 306. Probes 306 provide for outside measurements, such as outside diameters of cylindrical objects, and for inside measurements, such as the diameters of holes or bores. FIG. 3 also shows legs 304 with bent portions 308, as is illustrated by view A-A on one leg of legs 304. Bending legs 304 downward by some angle, such as 90 degrees, so that measurements of, for example, obstructed bores, can be made from an offset, allow for simplified avoidance of an obstruction such as objects (not shown) included in said bores (not shown).

Another embodiment of the present invention is shown in FIG. 4 which illustrates a vernier type caliper 400 in accordance with the teachings of the present invention. In FIG. 4, legs 402 and 404 include probes 408. Probes 408 enable measurements of either inside or outside dimensions, as revealed in the discussion of said probes 306 associated with FIG. 3. Slider 406 is connected rigidly to leg 404, and slides along beam 410. Beam 410 has graduations (not shown) to allow measurements in conjunction with a measurement point on slider 406, while leg 402 is rigidly connected to beam 410. Alternatively, a dial or similar readout device (not shown) allows measurements to be made. The ends of legs 402 and 404 are bent, such as downward at an angle of, for example, 90 degrees or other suitable angle, as illustrated with leg 408 in view A-A, at the ends of legs 402 and 404, so that probes 404 may be inserted in a hole or other restricted area when making a measurement, and without undue interference from an obstruction, such as a concentric structure (not shown) in a hole or bore (not shown).

Another embodiment of the present invention is shown in FIG. 5 which illustrates an extension type caliper in accordance with the teachings of the present invention. In FIG. 5, legs 502 and 504 include probes 508. Probes 508 enable measurements of either included or excluded dimensions, as revealed in the discussion of said probes 306 associated with FIG. 3. Slider 506 is connected rigidly to leg 504, and has been lengthened to provide for telescoping with beam 510 so that measurements may be made in restricted areas where said caliper must be contained within the measurement area. Slide 506 slides along beam 510, which has been shortened to prevent it from projecting beyond slide 506 when said caliper is making the smallest measurements allowed with this design. Beam 510 has graduations to allow measurements in conjunction with a measurement point on slider 506. Alternatively, a dial or similar readout device allows measurements to be made. The ends of legs 502 and 504 are bent, such as downward, at an angle of, for example, 90 degrees or other suitable angle, at the ends of legs 502 and 504, so that probes 508 may be inserted in a hole or other restricted area (not shown) without interfering with an obstruction, such as a concentric structure (not shown) in a hole or bore (not shown), when making a measurement.

I claim:

1. A scissors type caliper of a type commonly used in measurements in which the invention comprises: including offset measurement jaws deployed at an angle to a main plane of said caliper for measuring dimensions offset from said main plane of said caliper.

2. The caliper of claim 1 further including means for measuring both an internal dimension and an external dimension.

3. The caliper of claim 6 further including a readout, either digital or analog.

4. A vernier type caliper of a type commonly used in measurements in which the invention comprises:
including offset measurement jaws deployed at an angle to a main plane of said caliper for measuring dimensions offset from said main plane of said caliper.

5. The caliper of claim 3 further including means for measuring both an internal dimension and an external dimension.

6. The caliper of claim 3 further including a readout, either digital or analog.

7. A telescoping vernier type caliper of a type used in measurements in which the invention comprises: including offset measurement jaws deployed at an angle to a main plane of said caliper for measuring dimensions offset from said main plane of said caliper.

8. The caliper of claim 6 further including means for measuring both an internal dimension and an external dimension.

9. The caliper of claim 6 further including a readout, either digital or analog.
